(19) United States
(12) Patent Application Publication
(10) Pub. No.: US 2021/0215100 A1
(43) Pub. Date: Jul. 15, 2021

(54) BLOW DOWN IMPINGEMENT START SYSTEM

(71) Applicant: Rolls-Royce North American Technologies Inc., Indianapolis, IN (US)

(72) Inventors: Michael John Head, Mooresville, IN (US); Michael Karam, Plainfield, IN (US); Timothy C. Roesler, Plainfield, IN (US)

(73) Assignee: Rolls-Royce North American Technologies Inc., Indianapolis, IN (US)

(21) Appl. No.: 16/742,639

(22) Filed: Jan. 14, 2020

(51) Int. Cl. F02C 7/266; F23R 3/10; F23R 3/28

(52) U.S. Cl. CPC F02C 7/266; F23N 2227/36; F23R 3/286; F23R 3/10

(57) ABSTRACT

A start system for an expendable gas turbine engine is provided. The start system may include: a tank configured to store a pressurized gas comprising oxygen; a non-pyrotechnic igniter in communication with a combustion chamber of the expendable gas turbine engine; a starter tube configured to feed the pressurized gas from the tank into the combustion chamber; and a valve configured to regulate a flow of the pressurized gas from the tank into the starter tube; wherein, the start system is configured to startup the expendable gas turbine engine by the flow of the pressurized gas from the tank, through the valve and the starter tube, into the combustion chamber and, from the combustion chamber, into a plurality of turbine blades of the expendable gas turbine engine, and by ignition, by the non-pyrotechnic igniter, of fuel injected into the combustion chamber.

### TECHNICAL FIELD

This disclosure relates to gas turbine engines and, in particular, to start systems for gas turbine engines.

### BACKGROUND

Expendable gas turbine engines are gas turbine engines that are generally used only once. An expendable gas turbine engine may be used in, for example, an unmanned target aircraft such as a cruise missile.

The ignition environment of a gas turbine engine is very challenging during high altitude (10,000 feet to 35,000 feet) air drop missions. At the point of the drop, the pressure, temperature, and air mass flow are all low, and the entire gas turbine engine and fuel system are cold soaked to atmospheric temperatures (cold start). The ignition system or start system has to spool up the engine to a self-sustaining condition over a finite period of time and then light the combustor. For any particular gas turbine and start system, the resulting startup envelope is limited by Mach number, altitude, and environmental conditions, as well as time from start of ignition to self-sustaining operation. Small engines are more challenging to ignite due to the constraints on the combustor design, primarily the high surface to volume ratio and low fuel flow injectors.

Expendable gas turbine engines conventionally include a start system comprising a pyrotechnic gas generator. For example, the pyrotechnic gas generator may include a pyrotechnic start cartridge. The pyrotechnic gas generator provides fast spool up times and reliable high altitude starting.

Present startup systems for expendable gas turbine engines suffer from a variety of drawbacks, limitations, and disadvantages. Accordingly, there is a need for inventive systems, methods, components, and apparatuses described herein.

### BRIEF DESCRIPTION OF THE DRAWINGS

The embodiments may be better understood with reference to the following drawings and description. The components in the figures are not necessarily to scale. Moreover, in the figures, like-referenced numerals designate corresponding parts throughout the different views.

FIG. 1 illustrates an example of a start system for an expendable gas turbine engine, where the start system uses a tank of a pressurized gas instead of a pyrotechnic gas generator to spool up the engine;

FIG. 2 illustrates an example of a start system for an expendable gas turbine engine in which a torch provides a combination of an ignition source and the pressurized gas for spooling up the engine;

FIG. 3 illustrates an example of the start system that is the same as the start system shown in FIG. 2 except that the torch also includes a fuel tank that stores a fuel specifically for the torch;

FIG. 4 illustrates an example of a torch to ignite fuel in the combustion chamber;

FIG. 5 illustrates a torch that is the same as the torch shown in FIG. 4 except that the torch includes one or more air igniter air inlet ports instead of the tank comprising oxygen-containing gas; and

FIG. 6 is a cross-sectional view of an expendable gas turbine engine with the start system schematically shown.

### DETAILED DESCRIPTION

In a first example, a start system for an expendable gas turbine engine may be provided comprising: a tank configured to store a pressurized gas comprising oxygen; a non-pyrotechnic igniter in communication with a combustion chamber of the expendable gas turbine engine; a starter tube configured to feed the pressurized gas from the tank into the combustion chamber; and a valve configured to regulate a flow of the pressurized gas from the tank into the starter tube; wherein, the start system is configured to startup the expendable gas turbine engine by the flow of the pressurized gas from the tank, through the valve and the starter tube, into the combustion chamber and, from the combustion chamber, into a plurality of turbine blades of the expendable gas turbine engine, and by ignition, by the non-pyrotechnic igniter, of fuel injected into the combustion chamber.

In a second example, a start system for an expendable gas turbine engine may be provided, the start system comprising a torch, the torch including: a tank configured to store a pressurized gas comprising oxygen; a torch prechamber; a valve configured to regulate a flow of the pressurized gas from the tank into the torch prechamber; an ignition module comprising an electric igniter configured to ignite a fuel in the torch prechamber, the torch prechamber comprising a fuel inlet for the fuel; and a nozzle configured to feed a flow of the pressurized gas and an ignited fuel from the torch prechamber into a combustion chamber of the expendable gas turbine engine, wherein the ignited fuel forms a torch flame, wherein, the start system is configured to startup the expendable gas turbine engine by the flow of the pressurized gas from the nozzle into the combustion chamber and, from the flow of the pressurized gas continuing from the combustion chamber into a plurality of turbine blades of the expendable gas turbine engine, and by an ignition, by the torch flame, of a fuel injected into the combustion chamber by a fuel injector.

In a third example, a start system for an expendable gas turbine engine may be provided, the start system comprising a torch, the torch including: a torch body; a fuel tank configured to store a fuel; an igniter electrode configured to ignite, in the torch body, the fuel from the fuel tank in the presence of a gas comprising oxygen, the ignited fuel forming a torch flame, wherein the torch body is arranged to project the torch flame into a combustion chamber of a combustor of the expendable gas turbine engine, wherein the combustor does not include a pyrotechnic gas generator, and wherein, the start system is configured to startup the expendable gas turbine engine through an ignition, by the torch flame, of a fuel injected into the combustion chamber by a fuel injector.

One interesting feature of the systems and methods described below may be that the start system is substantially less expensive than a conventional start system comprising a pyrotechnic gas generator. The pyrotechnic gas generator may be expensive relative to the cost of the entire expendable gas turbine engine. As the gas turbine engine decreases in size, the percentage cost of the pyrotechnic gas generator may grow relative to the total cost. For example, the pyrotechnic gas generator may represent almost a third of the total cost of the gas turbine engine at the smallest scales. Alternatively, or in addition, an interesting feature of the systems and methods described below may be that the start system is more reliable than a start system comprising a pyrotechnic gas generator. Alternatively or in addition, the pyrotechnic gas generator introduces handling, fragility, and aging issues, that may not be present in the systems and methods described below. Conventionally used lower power ignition systems, such as spark ignitors or glow plugs, have restrictive startup flight envelopes and long spool up times. Such restrictions may be very mission limiting due to the need for dive-to-start and/or climb-to-cruise mission profiles resulting in significant inefficiencies and longer times to target. Such restrictions may also decrease the survivability of the ordinance.

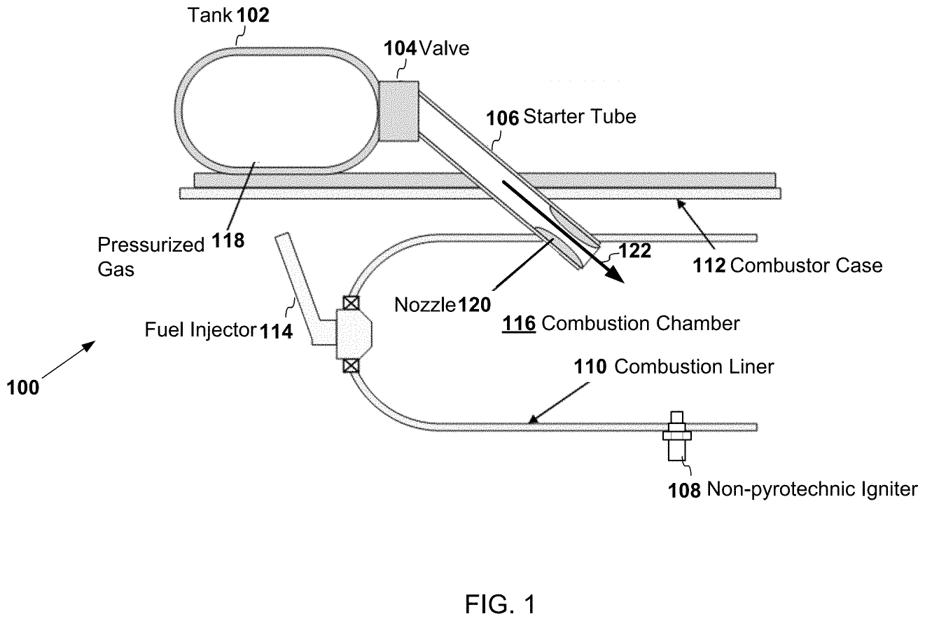

FIG. 1 illustrates an example of a start system 100 for an expendable gas turbine engine, where the start system 100 uses a tank 102 of a pressurized gas 118 instead of a pyrotechnic gas generator to spool up the engine. The start system 100 shown in FIG. 1 includes the tank 102, a valve 104, a starter tube 106, and a non-pyrotechnic igniter 108. The start system 100 is shown installed in a combustor that includes a combustion liner 110, a combustor case 112, and a fuel injector 114. The combustion liner 110 defines a combustion chamber 116.

The tank 102 is configured to store the pressurized gas 118 comprising oxygen or any other oxidizer. The pressurized gas 118 may be at a high pressure (in other words, greater than or equal to 100 psia). The non-pyrotechnic igniter 108 is in communication with the combustion chamber 116. The starter tube 106 is configured to feed the pressurized gas 118 from the tank 102 into the combustion chamber 116. The starter tube 106 in the example shown includes a nozzle 120.

The valve 104 is configured to regulate a flow 122 of the pressurized gas 118 from the tank 102 into the starter tube 106. Examples of the valve 104 may include a pressure regulator or any other type of valve that may regulate a flow 122 of the pressurized gas 118 from the tank 102 into the starter tube 106. For example, the valve 104 may be an electric solenoid valve adjusted by an electronic controller (not shown) in order to release the pressurized gas 118 at a target pressure or relative pressure. The electronic controller may be in communication with a sensor (not shown) in addition to the valve 104 to form a feedback loop. In such an arrangement, the electronic controller may adjust the valve 104, and consequently a flow through the valve 104, based on a sensed pressure so that the target pressure or relative target pressure is maintained.

During operation of the start system 100, the expendable gas turbine engine may be started by the flow 122 of the pressurized gas 118 from the tank 102, through the valve 104 and the starter tube 106, into the combustion chamber 116 and, from the combustion chamber 116, into turbine blades (not shown) of the expendable gas turbine engine, and by ignition by the non-pyrotechnic igniter 108 of fuel injected into the combustion chamber 116 by the fuel injector 114. The flow 122 of the pressurized gas 118 into the turbine blades causes a spool up of the gas turbine engine. The ignition of the fuel injected into the combustion chamber 116 by the fuel injector 114 may be performed as, or after, the spool up of the gas turbine engine completes, and/or sometime during the spool up. The spool up of the gas turbine engine completes when the engine reaches a target rotor speed, which, as is known in the art, is a rotor speed at which the engine is in a self-sustaining condition. After the engine reaches a stable sustained cycle speed, the valve 104 may be shut off, and the non-pyrotechnic igniter 108 may be turned off.

In some examples, the valve 104 may be an interface point for engine ground test starting with compressed air. For example the valve 104 may include two connectors and one outlet. A first connector of the valve 104 may be connected to a compressed gas source in a ground test starting unit. A second connector may be connected to the tank 102. The outlet of the valve 104 may be connected to the starter tube 106. The valve 104 may be switched to fill the tank 102 from the compressed gas source. Alternatively, the valve 104 may be switched to supply the compressed gas to the starter tube 106 from the compressed gas source. Alternatively, the valve 104 may be switched to connect the second connector to the outlet so that the compressed gas 118 may flow from the tank 102 to the starter tube 106. Alternatively the valve 104 may be switched so that no gas flows through the valve 104.

The combustion chamber 116 is not accessible to a pyrotechnic gas generator. In fact, the start system 100 does not include any pyrotechnic gas generator. In some examples, the start system 100, the combustor, and even the expendable gas turbine engine do not include any pyrotechnic gas generator.

The non-pyrotechnic igniter 108 may be any igniter that does not include a pyrotechnic such as a solid fuel. Examples of the non-pyrotechnic igniter 108 include an electric igniter or a torch igniter. The electric igniter uses electricity to cause a spark that ignites fuel in the combustion chamber 116. The torch igniter generates a flame that ignites fuel in the combustion chamber 116. The torch igniter generates the flame from a fuel that may or may not be the same fuel that is injected into the combustion chamber 116 by the fuel injector 114. In any case, the fuel(s) consumed by the torch igniter may be a liquid and/or a gas instead of a solid fuel used by a pyrotechnic gas generator. Examples of such a pyrotechnic gas generator may include a pyrotechnic start cartridge and/or a pyrotechnic igniter.

The pressurized gas 118 includes oxygen in order to facilitate burning of the fuel in the combustion chamber 116 in lower oxygen environments. Lower oxygen environments may result from the expendable gas turbine engine being started at a high altitude, such as greater than 36,000 feet above sea level. Examples of the pressurized gas may include air or any other oxygen containing gas.

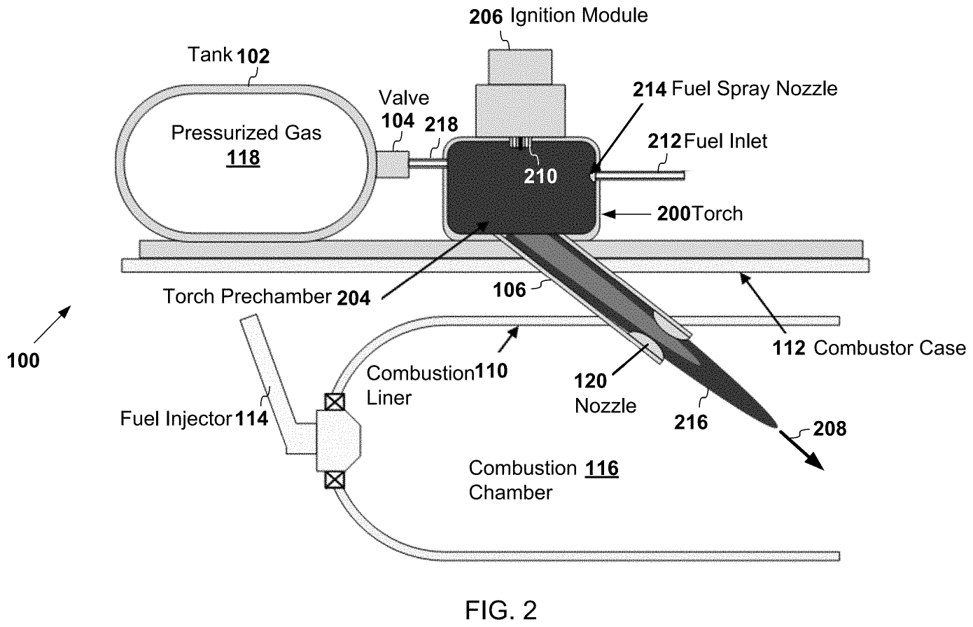

FIG. 2 illustrates an example of a start system 100 for an expendable gas turbine engine in which a torch 202 provides a combination of an ignition source and the pressurized gas for spooling up the engine. The torch 202 shown in FIG. 2 includes a tank 102, the valve 104, a torch prechamber 204, an ignition module 206, and the starter tube 106. The start system 100 is shown installed in the combustor, which includes the combustion liner 110, the combustor case 112, and the fuel injector 114. The combustion liner 110 defines the combustion chamber 116.

The tank 102 is configured to store the pressurized gas 118 comprising oxygen. The valve 104 is configured to regulate a flow 208 of the pressurized gas from the tank 102 into the torch prechamber 204 and, subsequently, through the starter tube 106 into the combustion chamber 116. Examples of the valve 104 may include a pressure regulator or any other type of valve that may regulate the flow 208 of the pressurized gas 118 from the tank 102 into the torch prechamber 204. For example, the valve 104 may be adjusted by an electronic controller (not shown) in order to release the pressurized gas 118 at a target pressure or relative pressure. The torch prechamber 204 includes an inlet 218 for the pressurized gas from the tank 102 of the pressurized gas 118. As explained above, the valve 104 may be an interface point for engine ground test starting with compressed air.

The ignition module 206 includes an electric igniter 210 configured to ignite a fuel in the torch prechamber 204. The torch prechamber 204 includes a fuel inlet 212 through which the fuel may be supplied to the torch prechamber 204. In some examples, a fuel spray nozzle 214 may atomize or otherwise distribute the fuel into the prechamber 204 as the fuel passes through the fuel inlet 212 and into the torch prechamber 204.

The starter tube 106 may include a nozzle 120 configured to feed the flow 208 of the pressurized gas 118 and an ignited fuel from the torch prechamber 204 into the combustion chamber 116. The ignited fuel forms a torch flame 216 extending from the nozzle 120 and/or the starter tube 106.

During operation of the start system 100, the expendable gas turbine engine may be started by the flow 208 of the pressurized gas from the nozzle into the combustion chamber and, from the flow 208 of the pressurized gas continuing from the combustion chamber 116 into turbine blades of the expendable gas turbine engine causes the engine to spool up. In addition, the torch flame 216 ignites a fuel injected into the combustion chamber 116 by the fuel injector 114. The ignition of the fuel injected into the combustion chamber 116 by the fuel injector 114 may be performed as, or after, the spool up of the gas turbine engine completes, and/or sometime during the spool up.

As shown in FIG. 2, the combustion chamber 116 is not in communication with a pyrotechnic gas generator. In fact, the start system 100 does not include any pyrotechnic gas generator. In some examples, the start system 100, the combustor, and even the expendable gas turbine engine do not include any pyrotechnic gas generator.

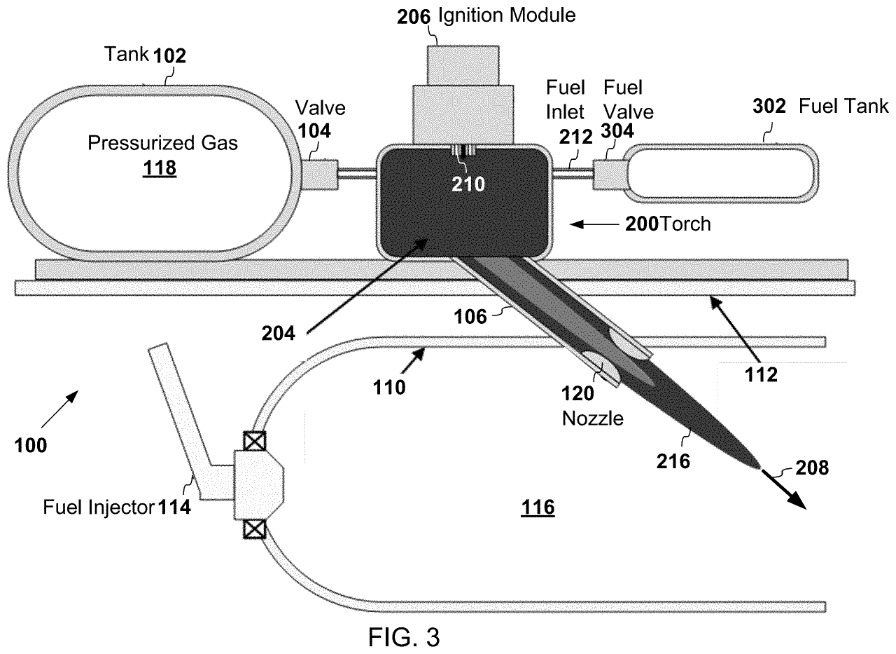

In some examples, fuel inlet 212 of the prechamber is in fluid communication with a fuel source that is also in fluid communication with the fuel injector 114. For example, both the torch 200 and the fuel injector 114 may be supplied with jet fuel from a common fuel tank. Alternatively, the torch 200 and the fuel injector 114 may be supplied with jet fuel from separate tanks. FIG. 3 shows one such example.

FIG. 3 illustrates an example of the start system 100 that is the same as the start system 100 shown in FIG. 2 except that the torch 200 also includes a fuel tank 302 that stores a fuel specifically for the torch 200. In particular, the fuel inlet 212 of the torch prechamber 204 is in fluid communication with the fuel tank 302. In the illustrated example, the torch 200 also includes a fuel valve 304 configured to control the flow of fuel from the fuel tank 302. An example of the fuel tank 302 may be a gas fuel bottle containing a liquid gas. The fuel in the fuel tank 302 may be jet fuel or any other type of liquid or gas fuel.

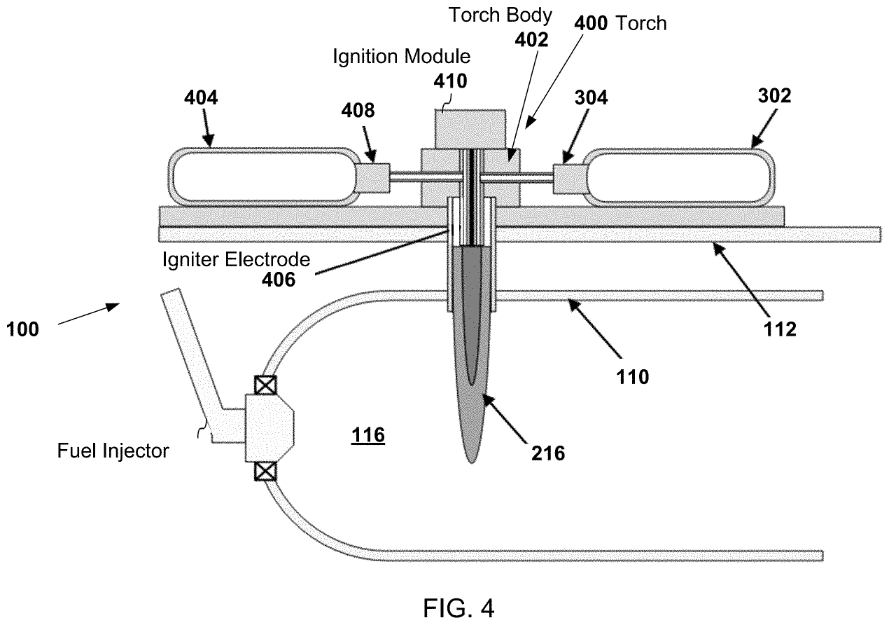

FIG. 4 illustrates an example of a torch 400 to ignite fuel in the combustion chamber 116. The torch 400 is a self-contained torch ignition system for inclusion in the start system 100. The illustrated example of the start system 100 uses a mechanism other than the torch 400 to spool up the expendable gas turbine engine. For example, the torch 400 shown in FIG. 4 may be one example of the non-pyrotechnic igniter 108 of the start system 100 shown in FIG. 1. The flow 122 of the pressurized gas 118 shown in FIG. 1 causes the expendable gas turbine engine to spool up as explained above.

The torch 400 shown in FIG. 4 includes a torch body 402, the fuel tank 302, an igniter electrode 406, and a tank 404 configured to store gas comprising oxygen. The torch 400 may include a valve 408, such as a pressure regulator, configured to control a flow of the gas comprising oxygen from the tank 404 into the torch body 402. The torch 400 may have the advantage of having high ignition energy, which is particularly important at high altitudes where low pressures and temperatures make ignition relatively difficult.

The igniter electrode 406 is configured to ignite, in the torch body 402, the fuel from the fuel tank 302 in the presence of the gas comprising oxygen, the ignited fuel forming the torch flame 216. The torch body 402 is arranged to project the torch flame into the combustion chamber 116. The combustion chamber 116 is not in communication with a pyrotechnic gas generator. In fact, the start system 100 does not include any pyrotechnic gas generator. In some examples, the start system 100, the combustor, and even the expendable gas turbine engine do not include any pyrotechnic gas generator.

The torch 400 may include an ignition module 410 in some examples. The ignition module 410 may be any device configured to control the electricity flow to the igniter electrode 406. For example, the ignition module 410 may control the duration and/or timing of the electricity flowing in order to control a spark generated by the igniter electrode 406. The spark may ignite the fuel in the torch body 402. An example of the ignition module 410 may include a low energy ignition module.

During operation of the start system 100, the expendable gas turbine engine is started through an ignition, by the torch flame 216, of a fuel injected into the combustion chamber 116 by a fuel injector 114. Before the torch flame 216 ignites the fuel in the combustion chamber 116, the expendable gas turbine engine is spooled up using, for example, the flow 122 of the pressurized gas 118 shown in FIG. 1 as explained above. Alternatively or in addition, ram jet air may cause the engine to spool up. For example, the engine may be dropped from a high altitude and/or an aircraft may transport the engine, where air flowing past or into the expendable gas turbine engine may operate as the ram jet air.

In some examples, the torch 400 may include the fuel valve 304. The fuel valve 304 is configured to control the flow of the fuel from the fuel tank 302 to the torch body 402.

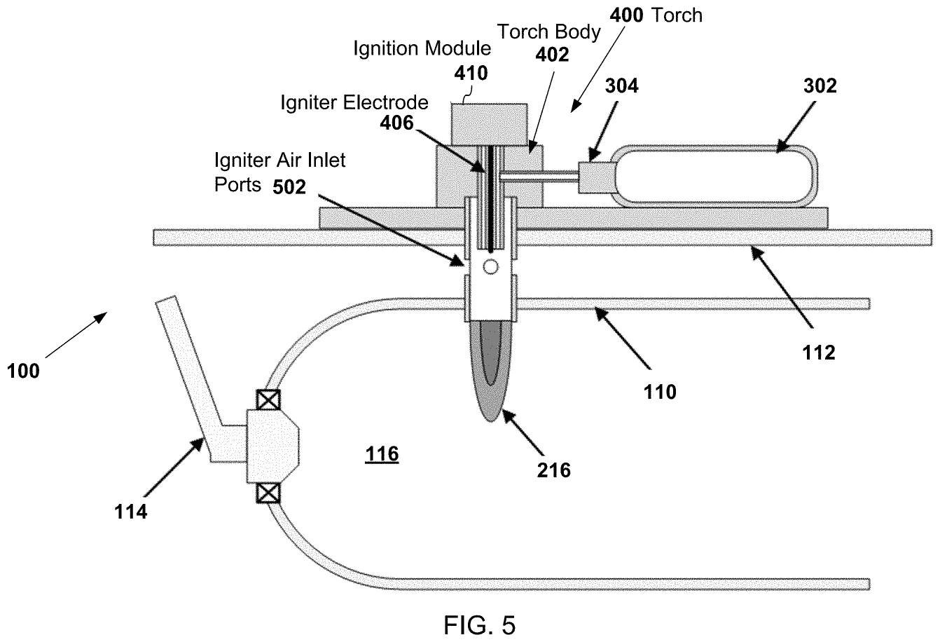

The torch 400 shown in FIG. 5 is the same as the torch 400 shown in FIG. 4 except that the torch 400 includes one or more air igniter air inlet ports 502 instead of the tank 404 comprising oxygen-containing gas. During operation of the start system 100 shown in FIG. 5, the torch 400 burns the fuel from the fuel tank 302 in the presence of air received through the air igniter air inlet ports 502 instead of from the pressurized gas received from the tank 404.

Each component may include additional, different, or fewer components. For example, the torch 400 may include the tank 404 of pressurized gas in some examples, but not in others.

The start system 100 may be implemented with additional, different, or fewer components. For example, the start system 100 may include one or more passages to the combustor that direct ram air to the combustor.

The components may be arranged differently than illustrated. For example, in FIGS. 1, 2 and 3, the starter tube 106 passes through the combustor case 112 and the combustion liner 110 and projects into the combustion chamber 116 at an angle. However, in other examples, the starter tube 106 may project into the combustion chamber 116 at a right angle to the combustion liner 110 at the point where the starter tube 106 passes through the combustion chamber 116. As another example, the starter tube 106 and the torch 400 are shown passing through the combustion liner 110 from the top of the figures toward the bottom of the figures. This may be considered a radially inward direction. However, the starter tube 106 and/or the torch 400 may be arranged instead to pass through the combustion liner 110 from the bottom of the figure(s) toward the top of the figure(s). This may be considered a radially outward direction. Alternatively, still other arrangements are possible.

The various examples illustrated may be combined. For example, the torch 400 shown in FIG. 4 or 5 may be operate as the non-pyrotechnic igniter 108 in the example shown in FIG. 1.

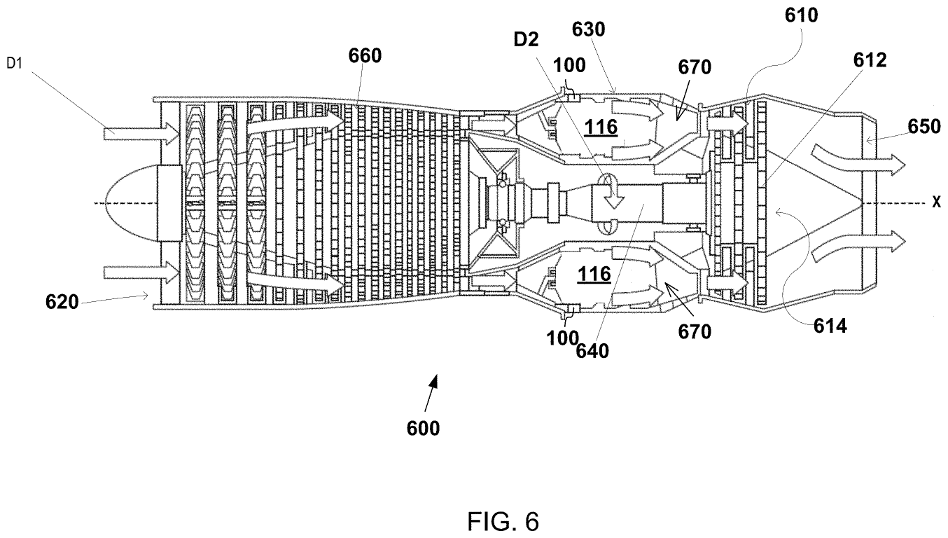

FIG. 6 is a cross-sectional view of an expendable gas turbine engine 600 with the start system 100 schematically shown. In some examples, the expendable gas turbine engine 600 may supply power to and/or provide propulsion of an aircraft. Examples of the aircraft may include a drone, an airplane, an unmanned space vehicle, a fixed wing vehicle, an unmanned combat aerial vehicle, a tailless aircraft, a hover craft, and any other airborne and/or extraterrestrial (spacecraft) vehicle. Alternatively or in addition, the expendable gas turbine engine 600 may be utilized in a configuration unrelated to an aircraft such as, for example, an energy application, a marine application (for example, for naval propulsion), a weapon system, a security system, a perimeter defense or security system.

The expendable gas turbine engine 600 may take a variety of forms in various embodiments. Though depicted as an axial flow engine, in some forms, the expendable gas turbine engine 600 may have multiple spools and/or may be a centrifugal or mixed centrifugal/axial flow engine. In some forms, the expendable gas turbine engine 600 may be a turboprop, a turbofan, or a turboshaft engine. Furthermore, the expendable gas turbine engine 600 may be an adaptive cycle and/or variable cycle engine. Other variations are also contemplated.

The expendable gas turbine engine 600 may include an intake section 620, a compressor section 660, a combustion section 630 comprising one or more combustors 670, a turbine section 610, and an exhaust section 650. During operation of the expendable gas turbine engine 600, fluid received from the intake section 620, such as air, travels along the direction D1 and may be compressed within the compressor section 660. The compressed fluid may then be mixed with fuel and the mixture may be burned in the combustor(s) 670 of the combustion section 630. The combustion section 630 may include the start system 100 and any suitable fuel injection and combustion mechanisms. The hot, high pressure fluid may then pass through the turbine section 610 to extract energy from the fluid and cause a turbine shaft of a turbine 614 in the turbine section 610 to rotate, which in turn drives the compressor section 660. Discharge fluid may exit the exhaust section 650.

As noted above, the hot, high pressure fluid passes through the turbine section 610 during operation of the expendable gas turbine engine 600. As the fluid flows through the turbine section 610, the fluid passes between adjacent blades 612 of the turbine 614 causing the turbine 614 to rotate. The rotating turbine 614 may turn a shaft 640 in a rotational direction D2, for example. The blades 612 may rotate around an axis of rotation, which may correspond to a centerline X of the turbine 614 in some examples. During operation of the start system 100, the pressurized gas 118 from the tank 102 may flow from the combustor(s) 670 to the turbine section 610 and then between the blades 612 of the turbine 614 causing the turbine 614 to rotate and spool up.

To clarify the use of and to hereby provide notice to the public, the phrases “at least one of <A>, <B>, . . . and <N>” or “at least one of <A>, <B>, . . . <N>, or combinations thereof” or “<A>, <B>, . . . and/or <N>” are defined by the Applicant in the broadest sense, superseding any other implied definitions hereinbefore or hereinafter unless expressly asserted by the Applicant to the contrary, to mean one or more elements selected from the group comprising A, B, . . . and N. In other words, the phrases mean any combination of one or more of the elements A, B, . . . or N including any one element alone or the one element in combination with one or more of the other elements which may also include, in combination, additional elements not listed. Unless otherwise indicated or the context suggests otherwise, as used herein, “a” or “an” means “at least one” or “one or more.”

While various embodiments have been described, it will be apparent to those of ordinary skill in the art that many more embodiments and implementations are possible. Accordingly, the embodiments described herein are examples, not the only possible embodiments and implementations.

The subject-matter of the disclosure may also relate, among others, to the following aspects:

A first aspect relates to a start system for an expendable gas turbine engine, the start system comprising: a tank configured to store a pressurized gas comprising oxygen; a non-pyrotechnic igniter in communication with a combustion chamber of the expendable gas turbine engine; a starter tube configured to feed the pressurized gas from the tank into the combustion chamber; and a valve configured to regulate a flow of the pressurized gas from the tank into the starter tube; wherein, the start system is configured to startup the expendable gas turbine engine by the flow of the pressurized gas from the tank, through the valve and the starter tube, into the combustion chamber and, from the combustion chamber, into a plurality of turbine blades of the expendable gas turbine engine, and by ignition, by the non-pyrotechnic igniter, of fuel injected into the combustion chamber.

A second aspect relates to the start system of aspect 1, wherein the combustion chamber is not in communication with a pyrotechnic gas generator.

A third aspect relates to the start system of any preceding aspect, wherein the non-pyrotechnic igniter comprises an electric igniter.

A fourth aspect relates to the start system of any preceding aspect, wherein the non-pyrotechnic igniter comprises a torch igniter.

A fifth aspect relates to the start system of any preceding aspect, wherein the pressurized gas comprises air.

A sixth aspect relates to the start system of any preceding aspect, wherein the valve comprises a pressure regulator.

A seventh aspect relates to a start system for an expendable gas turbine engine, the start system comprising a torch, the torch including: a tank configured to store a pressurized gas comprising oxygen; a torch prechamber; a valve configured to regulate a flow of the pressurized gas from the tank into the torch prechamber; an ignition module comprising an electric igniter configured to ignite a fuel in the torch prechamber, the torch prechamber comprising a fuel inlet for the fuel; and a nozzle configured to feed a flow of the pressurized gas and an ignited fuel from the torch prechamber into a combustion chamber of the expendable gas turbine engine, wherein the ignited fuel forms a torch flame, wherein, the start system is configured to startup the expendable gas turbine engine by the flow of the pressurized gas from the nozzle into the combustion chamber and, from the flow of the pressurized gas continuing from the combustion chamber into a plurality of turbine blades of the expendable gas turbine engine, and by an ignition, by the torch flame, of a fuel injected into the combustion chamber by a fuel injector.

An eighth aspect relates to the start system of aspect 7, wherein the combustion chamber is not in communication with a pyrotechnic gas generator.

A ninth aspect relates to the start system of any preceding aspect, wherein the fuel inlet of the torch prechamber is in fluid communication with a fuel source that is also in fluid communication with the fuel injector.

A tenth aspect relates to the start system of any preceding aspect, wherein the torch comprises a fuel tank in fluid communication with the fuel inlet of the torch prechamber.

An eleventh aspect relates to the start system of any preceding aspect, wherein the torch comprises a fuel spray nozzle in fluid communication with the fuel inlet.

A twelfth aspect relates to the start system of any preceding aspect, wherein the valve comprises a pressure regulator.

A thirteenth aspect relates to the start system of any preceding aspect, wherein the torch prechamber includes an inlet for the pressurized gas from the tank.

A fourteenth aspect relates to the start system of any preceding aspect, wherein the torch comprises a fuel valve.

A fifteenth aspects relates to a start system for an expendable gas turbine engine, the start system comprising a torch, the torch including: a torch body; a fuel tank configured to store a fuel; an igniter electrode configured to ignite, in the torch body, the fuel from the fuel tank in the presence of a gas comprising oxygen, the ignited fuel forming a torch flame, wherein the torch body is arranged to project the torch flame into a combustion chamber of a combustor of the expendable gas turbine engine, wherein the combustor does not include a pyrotechnic gas generator, and wherein, the start system is configured to startup the expendable gas turbine engine through an ignition, by the torch flame, of a fuel injected into the combustion chamber by a fuel injector.

A sixteenth aspect relates to the start system of aspect 15, wherein the torch comprises an igniter air inlet port to receive air, the air being the gas comprising oxygen.

A seventeenth aspect relates to the start system of any preceding aspect, wherein the torch comprises a tank configured to store the gas comprising oxygen.

A eighteenth aspect relates to the start system of aspect 17, wherein the torch comprises a pressure regulator configured to control a flow of the gas from the tank to the torch body.

A nineteenth aspect relates to the start system of any of aspects 17 to 18, wherein the torch comprises an ignition module configured to control the igniter electrode.

A twentieth aspect relates to the start system of any of aspects 17 to 19, wherein the torch comprises a fuel valve configured to control a flow of fuel into a fuel inlet of the torch body.

In addition to the features mentioned in each of the independent aspects enumerated above, some examples may show, alone or in combination, the optional features mentioned in the dependent aspects and/or as disclosed in the description above and shown in the figures.

1. A start system for an expendable gas turbine engine, the start system comprising:
a tank configured to store a pressurized gas comprising oxygen;
a non-pyrotechnic igniter in communication with a combustion chamber of the expendable gas turbine engine;
a starter tube configured to feed the pressurized gas from the tank into the combustion chamber; and
a valve configured to regulate a flow of the pressurized gas from the tank into the starter tube;
wherein, the start system is configured to startup the expendable gas turbine engine by the flow of the pressurized gas from the tank, through the valve and the starter tube, into the combustion chamber and, from the combustion chamber, into a plurality of turbine blades of the expendable gas turbine engine, and by ignition, by the non-pyrotechnic igniter, of fuel injected into the combustion chamber.

2. The start system of claim 1, wherein the combustion chamber is not in communication with a pyrotechnic gas generator.

3. The start system of claim 1, wherein the non-pyrotechnic igniter comprises an electric igniter.

4. The start system of claim 1, wherein the non-pyrotechnic igniter comprises a torch igniter.

5. The start system of claim 1, wherein the pressurized gas comprises air.

6. The start system of claim 1, wherein the valve comprises a pressure regulator.

7. A start system for an expendable gas turbine engine, the start system comprising a torch, the torch including:
a tank configured to store a pressurized gas comprising oxygen;
a torch prechamber;
a valve configured to regulate a flow of the pressurized gas from the tank into the torch prechamber;
an ignition module comprising an electric igniter configured to ignite a fuel in the torch prechamber, the torch prechamber comprising a fuel inlet for the fuel; and
a nozzle configured to feed a flow of the pressurized gas and an ignited fuel from the torch prechamber into a combustion chamber of the expendable gas turbine engine, wherein the ignited fuel forms a torch flame,
wherein, the start system is configured to startup the expendable gas turbine engine by the flow of the pressurized gas from the nozzle into the combustion chamber and, from the flow of the pressurized gas continuing from the combustion chamber into a plurality of turbine blades of the expendable gas turbine engine, and by an ignition, by the torch flame, of a fuel injected into the combustion chamber by a fuel injector.

8. The start system of claim 7, wherein the combustion chamber is not in communication with a pyrotechnic gas generator.

9. The start system of claim 7, wherein the fuel inlet of the torch prechamber is in fluid communication with a fuel source that is also in fluid communication with the fuel injector.

10. The start system of claim 7, wherein the torch comprises a fuel tank in fluid communication with the fuel inlet of the torch prechamber.

11. The start system of claim 7, wherein the torch comprises a fuel spray nozzle in fluid communication with the fuel inlet.

12. The start system of claim 7, wherein the valve comprises a pressure regulator.

13. The start system of claim 7, wherein the torch prechamber includes an inlet for the pressurized gas from the tank.

14. The start system of claim 7, wherein the torch comprises a fuel valve.

15. A start system for an expendable gas turbine engine, the start system comprising a torch, the torch including:
a torch body;
a fuel tank configured to store a fuel;
an igniter electrode configured to ignite, in the torch body, the fuel from the fuel tank in the presence of a gas comprising oxygen, the ignited fuel forming a torch flame,
wherein the torch body is arranged to project the torch flame into a combustion chamber of a combustor of the expendable gas turbine engine,
wherein the combustor does not include a pyrotechnic gas generator, and
wherein, the start system is configured to startup the expendable gas turbine engine through an ignition, by the torch flame, of a fuel injected into the combustion chamber by a fuel injector.

16. The start system of claim 15, wherein the torch comprises an igniter air inlet port to receive air, the air being the gas comprising oxygen.

17. The start system of claim 15, wherein the torch comprises a tank configured to store the gas comprising oxygen.

18. The start system of claim 17, wherein the torch comprises a pressure regulator configured to control a flow of the gas from the tank to the torch body.

19. The start system of claim 17, wherein the torch comprises an ignition module configured to control the igniter electrode.

20. The start system of claim 17, wherein the torch comprises a fuel valve configured to control a flow of fuel into a fuel inlet of the torch body.
